(19) United States
(12) Patent Application Publication
(10) Pub. No.: US 2021/0153307 A1
(43) Pub. Date: May 20, 2021

(54) METHOD FOR MANUFACTURING AN ELEMENT FOR A BODYWORK COMPONENT COMPRISING IMPROVED DEICING MEANS

(71) Applicant: COMPAGNIE PLASTIC OMNIUM, Lyon (FR)

(72) Inventors: Frèdèric STABLO, Porcieu Amblagnieu (FR); Georges FRAPPA, Lyon (FR); Elise DUBOST, Villars les Dombes (FR); Jèrôme GRANDO, Vertrieu (FR); Guillaume BOITEUX, Lyon (FR); David TRESSE, Saint-Andre de Corcy (FR); Constantin MURARIU, Chassieu (FR); Sèbastien CHARNAUX, Journans (FR)

(73) Assignee: COMPAGNIE PLASTIC OMNIUM, Lyon (FR)

(21) Appl. No.: 17/047,553

(22) PCT Filed: Apr. 19, 2019
(86) PCT No.: PCT/EP2019/060241

§ 371 Date: Oct. 14, 2020

(30) Foreign Application Priority Data
Apr. 19, 2018 (FR) 1853420

(51) Int. Cl. H05B 3/84; B29C 45/14; B29C 45/16; H01Q 1/02; H01Q 1/32

(52) U.S. Cl. CPC H05B 3/84; B29C 45/14344; B29C 45/14639; B29L 2031/3005; H01Q 1/02; H01Q 1/3233; B29C 45/1671

(57) ABSTRACT

A method for manufacturing an element for a bodywork component is provided. The method, characterized in that a rough form made of plastic and comprising at least one housing on a first face is manufactured, a connection member comprising a first end accessible from the side of the first face of the rough form and a second end accessible from the side of a second face of the rough form is pre-positioned with respect to the rough form, a heating track is positioned on the first face of the rough form, a connection part of the track is affixed to the first end of the connection member, the first end of the connection member and the connection part of the track are squeezed together and welded by the input of electrical energy, the first end of the connection member is positioned in the housing, and an additional layer of plastic is over molded.

### CROSS-REFERENCE TO RELATED APPLICATIONS

This application claims priority under 35 U.S.C. § 371 to the International Application No. PCT/EP2019/060241, filed Apr. 19, 2019, and to the French Application No. 1853420, filed Apr. 19, 2018, now pending, the contents of which are hereby incorporated by reference.

The invention relates to the field of manufacturing a plastic element intended to be mounted on a motor vehicle bodywork component. Many modern vehicles are equipped with bodywork components made of plastic that can be fitted, for example, to a tailgate, a door side, front and rear bumpers, a roof, etc.

In particular, since the introduction of driver assistance systems, it has been necessary to place sensors of various kinds on certain plastic bodywork components in order to measure external physical parameters representative of the external environment of the motor vehicle. The values of these parameters together form real-time information about the vehicle environment.

Bodywork elements are thus used which are attached to the bodywork component and have, for example, a radome function, i.e. an element transparent to electromagnetic waves protecting and concealing sensors.

As an example, bumpers are now frequently equipped with proximity radars to assist the driver during parking maneuvers of the motor vehicle at low speeds.

Some sensors, such as the one in the example above, may be affected by a layer of ice, snow or frost in temperatures below 10 degrees Celsius because the movement of the vehicle has a negative effect on the temperature. Frost deposits can therefore be observed even at positive temperatures. A layer of frost disturbs the normal passage of electromagnetic waves and is a source of error in the measurement of external physical parameters.

In order to avoid the deposit of frost, which not only renders the assistance system unusable, but can also generate false alarms, it is essential to provide a deicing system on the element for a bodywork component, for example on the area of the bodywork component that serves as a radome.

Such a deicing system is traditionally made up of a heating track formed of conductive wires capable of transforming electrical energy into thermal energy, associated with two connection plates at each end of the heating track in order to supply it with electrical current, the whole being positioned on an element of a bodywork component and close to a sensor. The thermal energy thus released makes it possible to de-ice the part locally in the event of a layer of frost forming. The heating track, to avoid disturbing the passage of electromagnetic waves, must be positioned according to a particular geometry designated in the following by a “serpentine” positioning. For the sake of clarity, a serpentine heating track is defined as follows: a serpentine heating track follows a boustrophedon path, i.e. a path that describes parallel segments with 180° turns between two segments that rotate alternately in one direction and then in the opposite direction with a constant distance between two parallel segments.

Furthermore, a serpentine track designates a track of which the positioning allows the passage of electromagnetic waves characterized by a certain frequency range.

Indeed, the accuracy of the positioning of the heating track is very important in order to prevent it obstructing the passage of electromagnetic waves; in particular, the parallelism between the different segments of the heating tracks and the spacing between these heating tracks must be respected very precisely. For each frequency of electromagnetic wave, there will be a corresponding configuration of the optimal positioning of the heating track so that this heating track is transparent with respect to the passage of this electromagnetic wave.

Such an embodiment does not protect the connecting plates or the conductive track from the aggressions that can occur from the inside of the element for a bodywork component once mounted on a vehicle, such as corrosion. Vibrations and jolts can also after and/or damage the deicing system in the long term, in particular the connection to a connector that allows the electrical supply of the deicing system. In addition, the molding of the bodywork element is complicated by the presence of conductive pins that must be kept partly outside the molding area, so that they are not covered with plastic so as to maintain their conductive properties. Lastly, it is often necessary to re-solder the conductive pins in order to electrically power the deicing system, for example via a standard connector.

The invention aims to overcome these drawbacks by proposing an easily industrializable method which allows a good positioning and adhesion of the deicing system on an element for a bodywork component in a simple, efficient and watertight way, and which ensures, in particular, an easy and robust connection with a connector, giving the final device a very significant reliability and life span.

To this end, the invention relates to a method for producing an element for a bodywork component, characterized in that:
a rough form made of plastic and comprising at least one housing on a first face of the rough form is manufactured, said housing comprising at least one orifice extending between a bottom of the housing and a second face of the rough form opposite the first face,
an electrically conductive connection member comprising a first end accessible from the side of the first face of the rough form and a second end extending through the orifice in the rough form so as to be accessible from the side of the second face of the rough form is pre-positioned with respect to the rough form.
an electrically conductive heating track is positioned on the first face of the rough form, the heating track comprising a connection part which is free with respect to this first face,
the connection part of the track is affixed to the first end of the connection member,
the first end of the connection member and the connection part of the track are squeezed together,
the first end of the connection member and the connection part of the track are welded together by the input of electrical energy,
the first end of the connection member is positioned in the housing,
an additional layer of plastic is overmolded on the first face of the rough form so as to cover the heating track, the first end of the connection member, the housing and the orifice in the rough form.

This ensures a good cohesion between the connection member and the connection part of the heating track by ensuring good contact between them through simple squeezing and welding steps, in order to obtain a robust element for a bodywork component. The connection between the connection member and the heating track is thus very reliable. In addition, the covering of the rough form with an additional layer ensures that the heating track and the connection member are sealed and steadied, thus avoiding external influences such as corrosion. Furthermore, by housing the connection member in the housing, there is no, or very limited protrusion from the first face of the rough form, which makes it possible to avoid the formation of bosses once the additional layer is overmolded.

The method according to the invention may also include the following optional features:
The connection part of the track is affixed to the first end of the connection member by forming at least one coil of the connection part of the track around the first end of the connection member. This thus makes it possible to form an easily implemented and good-quality attachment, contributing to the reliability and robustness of the connection between the heating track and the connection member.
The welding energy is supplied via a tool squeezing the first end of the connection member with the connection part of the track, this tool preferably being used during the squeezing step.
This thus facilitates the method by limiting the use and changing of tools whilst the method is being carried out.
The first end of the electrical connection member is formed by a tab bent in a hook shape comprising a web connecting a first free branch and a second branch intended to be in contact with the bottom of the housing, the second end of the connection member being formed by an extension of the second branch, bent with respect to the second branch. This facilitates the implementation of the method by making it easy to make a coil around the tab bent in a hook shape and to ensure good-quality squeezing and welding while increasing the production rate, as the tab bent in a hook shape is squeezed around the connection part of the heating track.
The additional layer of plastic completely covers the heating track.
This ensures that the entire heating track is perfectly sealed to protect it from external aggressions such as corrosion or shocks.
The heating track is positioned on the plastic rough form in an arrangement compatible with the passage of electromagnetic waves through the plastic element, these waves being intended to be emitted by a sensor to be mounted perpendicularly to the element. This thus makes it possible to ensure that the heating track does not after the signal of the sensor in front of which it is located.
The heating track also comprises a serpentine deicing portion. This ensures that the heating track is not detected by the electromagnetic waves of the sensor in front of which it is located and does not alter its signal.
Prior to the welding step, a layer of insulation covering the heating track is locally destroyed by inputting electrical energy via a tool squeezing the first end of the connection member with the connection part of the track, preferably used in the squeezing step.
This ensures a direct contact between the first end of the connection member and the heating track to guarantee a good electrical connection.
The heating track is fixed on the first face of the rough form by welding by heating the track to a temperature allowing local melting of the plastic of the rough form.
This allows the heating track to be welded onto the rough form, thus ensuring the correct position of the heating track on the rough form.
The connection member is held in position in the housing by means of complementary snap-in means carried on the second end of the connection member and the second face of the rough form, for example by means of a snap-in tab carried by the second end and cooperating with the second face of the rough form.
This ensures that the connection member is correctly held in position in the housing.

The invention also relates to an element for a bodywork component, characterized in that it comprises:
a plastic rough form comprising at least one housing on a first face of the rough form, said housing comprising at least one orifice extending between a bottom of the housing and a second face of the rough form opposite the first face,
an electrically conductive heating track positioned on the first face of the rough form, the heating track comprising a connection part,
an electrically conductive connection member comprising a first end positioned in the housing of the rough form and a second end extending through the orifice in the rough form so as to be accessible from the side of the second face of the rough form, the connection part of the heating track forming at least one coil around the first end of the connection member, the first end and the coil of the connection part of the track being squeezed and welded together,
an additional layer of plastic, overmolded on the first face of the rough form, covering the heating track, the first end of the connection member, the housing and the orifice in the rough form.

This makes it possible to ensure a good cohesion between the connection member and the connection part of the heating track, the first end of the connection member being squeezed and welded with the coil of the connection part of the heating track in order to ensure a robust connection. The connection between the connection member and the heating track is thus very reliable, the heating track and the connection member are very well protected with an excellent seal, and external aggressions such as corrosion are avoided. The connection member allows the heating track to be easily connected to a power supply, for example via a standard connector. In addition, the additional layer allows complete material continuity between the material layer protecting the device and the plastic element, so that no air bubbles remain that could disturb the passage of electromagnetic waves, especially in the area of the bodywork component that serves as a radome. Lastly, the additional layer makes it possible to improve the resistance of the connection between the connection member and the heating track to the vibrations of the vehicle on which the element for a bodywork component is mounted during use.

The element for a bodywork component according to the invention may also have the following optional features:
The connection part of the heating track is affixed to the first end of the connection member, forming at least one coil of the connection part of the heating track around the first end of the connection member. This thus allows for a quality attachment, contributing to the reliability and robustness of the connection between the heating track and the connection member.
The first end of the electrical connection member is formed by a tab bent in a hook shape comprising a web connecting a first free branch and a second branch intended to be in contact with the bottom of the housing, the second end of the connection member being formed by an extension of the second branch, bent with respect to the second branch. This makes it possible to ensure excellent cohesion between the connection member and the connection part of the heating track, the tab bent in a hook shape being squeezed around the connection part of the heating track. This makes it possible to ensure a very robust connection, and in particular to resist the vibrations produced during the use of a vehicle on which the element is mounted.
The connection member is held in position in the housing by means of complementary snap-in means carried on the second end of the connection member and the second face of the rough form, for example by means of a snap-in tab carried by the second end and cooperating with the second face of the rough form.
This thus makes it possible to ensure the position of the connection member in the housing, even in the event of strong vibrations produced during the use of a vehicle on which the element is mounted.
The heating track is positioned on the plastic rough form in an arrangement that is compatible with the passage of electromagnetic waves through the plastic element, these waves being intended to be emitted by a sensor to be mounted perpendicularly to the element.
This thus makes it possible to ensure that the heating track does not alter the signal of the sensor in front of which it is located.
The heating track also comprises a serpentine deicing portion.
This thus makes it possible to ensure that the heating track is not detected by the electromagnetic waves of the sensor in front of which it is located and does not alter its signal.
   The heating track comprises an electrically conductive material selected from copper, tungsten or an alloy comprising copper or tungsten.
   This thus allows the heating track to be a good electrical conductor and to heat up when an electric current passes through it.
   The heating track is covered with a layer of insulation.
   This thus makes it possible to protect the heating track.
   The insulation is chosen from enamel or insulating paint.
   This thus allows the heating track to be covered with effective insulation.
   The heating track is fixed on the first side of the rough form by locally melting the plastic of the rough form.
   This allows the heating track to be welded onto the rough form, thus ensuring the correct position of the heating track on the rough form, and makes it possible to resist the vibrations of the vehicle on which the element for a bodywork component is mounted during use.

The invention will be better understood by reading the following description given by way of example and made with reference to the drawings, in which:

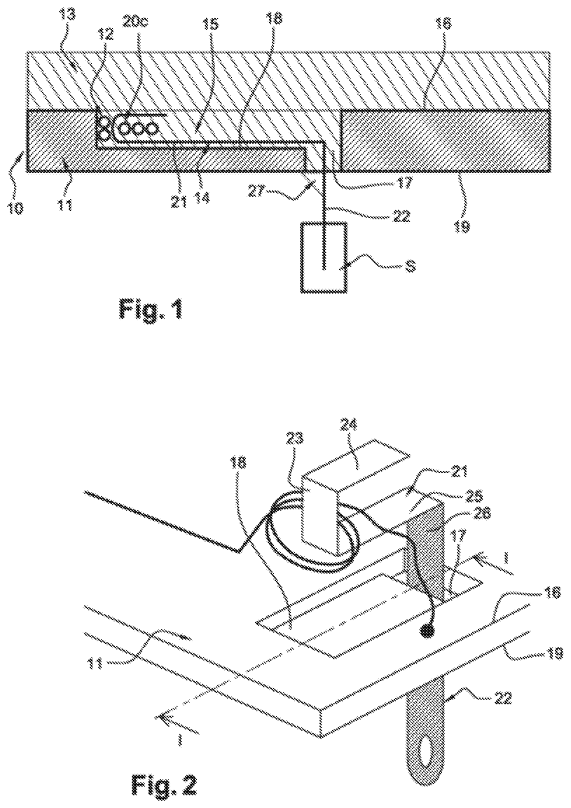

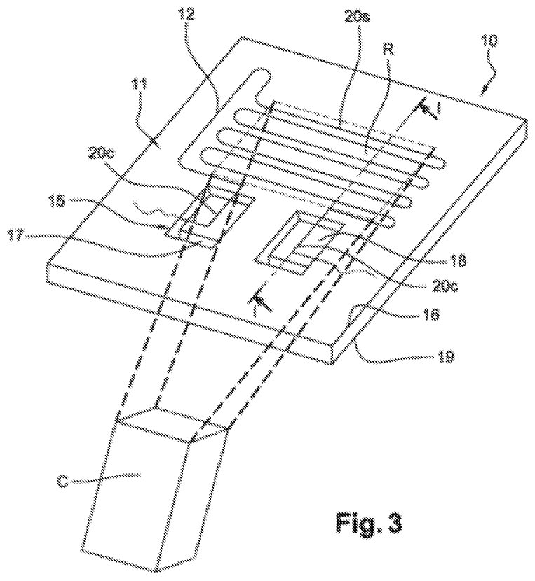

FIG. 1 is a schematic cross-sectional view along the plane I-I of FIGS. 2 and 3, showing a part of an element for a bodywork component according to the invention, this Figure showing a connection member in a housing on a first face of a rough form;

FIG. 2 is a schematic perspective view showing a part of the element for a bodywork component during a step of the manufacturing method according to the invention, this Figure showing the connection member pre-positioned with respect to the rough form, around which two coils of a connection part of a heating track are formed;

FIG. 3 is a schematic perspective view showing the element for a bodywork component during a manufacturing step according to the invention, this Figure showing a rough form on which a heating track is positioned;

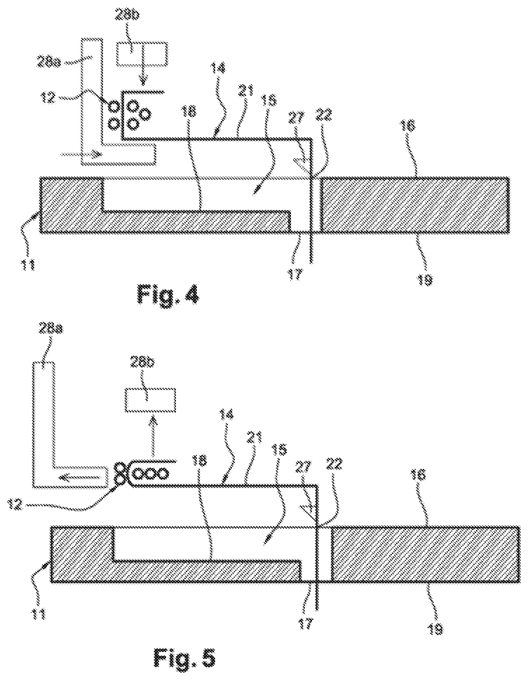

FIG. 4 is a schematic sectional view along the plane I-I of FIGS. 2 and 3, showing a part of an element for a bodywork component according to the invention, this Figure showing the placement of a squeezing tool prior to the step of squeezing the first end of the connection member and the turns of the connection part of the track between them;

FIG. 5 is a schematic cross-sectional view along the plane I-I of FIGS. 2 and 3, showing a part of an element for a bodywork component according to the invention, this Figure showing the removal of the squeezing tool after the step of squeezing the first end of the connection member and the turns of the connection part of the track between them.

FIG. 1 shows part of a component 10 that is intended to be connected to a bodywork component of a motor vehicle, such as a tailgate, door side, front or rear bumper, or roof, to protect and conceal a sensor C on the vehicle. Specifically, the element 10 has a radome function for the sensor C.

The element 10 for a bodywork component comprises a plastic rough form 11, a heating track 12, an additional plastic layer 13 and an electrically conductive connection member 14.

The plastic rough form 11 has at least one housing 15. The housing 15 is located on a first face 16 of the rough form 11.

The housing 15 comprises an orifice 17 that extends between a bottom 18 of the housing 15 and a second face 19 of the rough form 11 opposite the first face 16.

In the example described, the rough form 11 has two housings 15, as shown in FIG. 3, each with an orifice 17.

Referring to FIGS. 2 and 3, it can be seen that the heating track 12 is positioned and fixed by local melting of the plastic on the first face 16 of the rough form 11, that is to say a melting at the periphery of the heating track 12 which is deposited on the first face 16 of the rough form 11. This track 12 comprises, for each housing 15, a part referred to as a connection part 20c, extending at the level of the housing 15 of the rough form 11. The track 12 also comprises a serpentine deicing portion 20s intended to be placed on the area of the element 10 which serves as a radome. The serpentine deicing portion 20s of the heating track 12 is positioned on the rough form 11 in an arrangement compatible with the passage of electromagnetic waves through the plastic element 10. These waves are intended to be emitted by the sensor C to be mounted on the element 10. In the example described, the serpentine deicing portion 20s of the heating track 12 follows a boustrophedon path.

The heating track 12 comprises an electrically conductive material. In the example described, the heating track 12 comprises copper covered with an insulating enamel layer. It should be noted that the heating track 12 can, for example, comprise tungsten or an alloy based on copper or tungsten. In addition, the insulating layer may, for example, comprise an insulating paint instead of enamel. When a current flows through the heating track 12, it releases calories by the Joule effect. Lastly, in the example described, the heating track 12 has a diameter between 300 and 500 μm.

As can be seen in FIG. 1, the electrically conductive connection member 14 has a first end 21 positioned in the housing 15 of the rough form 11. The connection member 14 also has a second end 22 extending through the orifice 17 in the rough form 11 and intended to be connected to a standard connector S. The second end 22 of the connection member 14 is thus accessible from the side of the second face 19 of the rough form 11. In addition, the connection part 20c of the track 12 is affixed to the first end 21 of the connection member 14 by forming at least one coil around the first end 21 of the connection member 14. The first end 21 of the connection member 14 and the coil of connection part 20c are squeezed and welded together. In the described example, the connection part 20c of the track 12 forms two turns around the first end 21 of the connection member 14. The insulating enamel layer of the heating track 12 is locally destroyed at a contact area between the first end 21 of the connection member 14 and the connection part 20c of the heating track 12.

In the example described, the first end 21 of the electrical connection element 14 is formed by a tab bent in a hook shape comprising a web 23 connecting a first free branch 24 and a second branch 25 intended to be in contact with the bottom 18 of the housing 15. The second end 22 of the connection member 14 is formed by an extension 26 of the second branch 25, bent with respect to the second branch 25, for example at right angles. In addition, the connection member 14 comprises a silver-copper alloy.

The connection member 14 may also comprise a snap-in tab 27 carried by the second end 22 of the connection member 14 so as to be held in position in the housing 15. This snap-in tab 27 cooperates with the second face 19 of the rough form 11.

Lastly, the additional plastic layer 13 overmolds the first face 16 of the rough form 11. Thus, in the example described, the additional layer 13 covers the heating track 12, the first end 21 of the connection member 14, the housing 15 and the orifice 17 in the rough form 11.

A method according to the invention for manufacturing the element 10 for a bodywork component will be described below.

First of all, the rough form 11 made of plastic is manufactured. In the example described, the rough form 11 comprises two housings 15, each with an orifice 17.

Then, as shown in FIGS. 2, 4 and 5, the electrically conductive connection member 14 is pre-positioned with respect to the rough form 11. The first end 21 of the connection member 14 is accessible from the side of the first face 16 of the rough form 11. The second end 22 of the connection member 14 extends through the orifice 17 in the rough form 11 so as to be accessible from the side of the second face 19 of the rough form 11. The second end can thus be connected, directly or not, to a standard connector S.

The electrically conductive heating track 12 is then positioned on the first face 16 of the rough form 11, for example with the aid of a sonotrode. The heating track 12 comprises a connection part 20c at the housing 15 of the rough form 11, which connection part is free with respect to the first face 16 of the rough form 11 so as to facilitate its connection to the connection member 14. As shown in FIG. 3, the serpentine deicing portion 20s of the heating track 12 is positioned on the rough form 11 following a boustrophedon path.

In the example described, the heating track 12 is welded to the first face 16 of the rough form 11 by heating the heating track 12, for example by generating an electric current or ultrasound in the heating track 12, to a temperature that allows local melting of the plastic of the rough form 11.

Subsequently, the connection part 20c of the track 12 is affixed to the first end 21 of the connection member 14 by forming at least one coil of the connection part 20c of the track 12 around the first end 21 of the connection member 14. In the example described, as shown in FIG. 2, two coils of the connection part 20c of the track 12 are formed around the web 23 of the first end 21 of the connection member 14. Thus, a large contact area is formed between the connection member 14 and the heating track 12.

Referring to FIGS. 4 and 5, the first end 21 of the connection part 14 and the two coils of the connection part 20c of the heating track 12 are then squeezed together using a squeezing tool 28. In the example described, the squeezing tool 28 comprises an anvil 28a and a squeezing member 28b, which carries electrical energy.

Then, the insulating enamel layer covering the heating track 12 is locally destroyed. In the example described, the insulating enamel layer is destroyed by inputting electrical energy via a tool that squeezes the first end 21 of the connection member 14 with the connection part 20c of the track 12. The combination of the effect of the energy input and the mechanical effect of the squeezing effectively destroys the insulation layer. It should be noted that the amount of energy input is related to the thickness and nature of the insulation and that preferably the squeezing tool 28 used during the squeezing step is used.

Next, the first end 21 of the connection member 14 and the two coils of the connection part 20c of the track 12 are welded together, for example by the input of electrical energy. In the example described, the welding energy is applied via a tool squeezing the first end 21 of the connection member 14 with the connection part 20c of the track 12. It should be noted that the intensity of the electric current or ultrasound depends on the material forming the heating track 12 and may be different from the intensity used to destroy the insulation layer. It should also be noted that the squeezing tool 28 used during the squeezing step is preferably used. The same tool can thus be used to squeeze together the first end 21 of the connection member 14 and the two coils of the connection part 20c of the heating track 12 and to destroy the enamel layer and to weld the first end 21 of the connection member 14 to the connection part 20c of the track 12. In addition, a large contact surface is formed between the connection member 14 and the heating track 12, thus ensuring a robust and quality electrical connection.

It should be noted that the pre-positioning of the connection member 14 with respect to the rough form allows free access to the first end 21 of the connection member 14 for squeezing and welding means.

The first end 21 of the connection member 14 is then positioned in the housing 15. It should be noted that, as shown in FIG. 1, the connection member 14 can be held in the housing 15 with the aid of the snap-in tab 27 carried by the second end 22 of the connection member 14 and cooperating with the second face 19 of the rough form 11.

Lastly, the additional layer 13 of plastic is overmolded on the first face 16 of the rough form 11 so as to cover the heating track 12, the first end 21 of the connection member 14, the housing 15 and the orifice 17 of the rough form 11. It should be noted that, in the example described, the additional layer 13 of plastic completely covers the heating track 12 in order to provide good protection against shocks and corrosion of the track 12 and good sealing of the assembly 10. In addition, the additional layer 13, by filling the orifice 17, improves the resistance of the connection between the connection member 14 and the heating track 12 to the vibrations of the vehicle on which the element for a bodywork component is mounted during use.

The invention is not limited to the embodiment presented, and other embodiments will clearly be apparent to a person skilled in the art. In particular, the first end 21 of the connection member 14 may have teeth and the attachment may be achieved by winding or engaging the connection part 20c of the heating track 12 around teeth formed by the first end 21 of the connection member 14. In addition, the connection member 14 can be held in position in the housing 15 by means of complementary snap-in means carried on the second end 22 of the connection member 14 and the second face 19 of the rough form 11, for example the snap-in tab 27 can be carried on the second face 19 of the rough form 11 or on a wall of the orifice 17.

1. Method for manufacturing an element for a bodywork component, characterized in that:
a rough form made of plastic and comprising at least one housing on a first face of the rough form, said housing comprising at least one orifice extending between a bottom of the housing and a second face of the rough form opposite the first face is manufactured,
an electrically conductive connection member comprising a first end accessible from the side of the first face of the rough form and a second end extending through the orifice in the rough form so as to be accessible from the side of the second face of the rough form is pre-positioned with respect to the rough form,
an electrically conductive heating track is positioned on the first face of the rough form, the heating track comprising a connection part which is free with respect to this first face,
the connection part of the track is affixed to the first end of the connection member,
the first end of the connection member and the connection part of the track are squeezed together,
the first end of the connection member and the connection part of the track are welded together by the input of electrical energy,
the first end of the connection member is positioned in the housing,
an additional layer of plastic is overmolded on the first face of the rough form so as to cover the heating track, the first end of the connection member, the housing and the orifice in the rough form.

2. Method for manufacturing an element for a bodywork component according to claim 1, wherein the connection part of the track is affixed to the first end of the connection member by forming at least one coil of the connection part of the track around the first end of the connection member.

3. Method for manufacturing an element for a bodywork component according to claim 1, wherein the welding energy is supplied via a tool squeezing the first end of the connection member with the connection part of the track, this tool preferably being used in the squeezing step.

4. Method for manufacturing an element for a bodywork component according to claim 1, wherein the first end of the electrical connection member is formed by a tab bent in a hook shape comprising a web connecting a first free branch and a second branch intended to be in contact with the bottom of the housing, and wherein the second end of the connection member is formed by an extension of the second leg, bent with respect to the second leg.

5. Method for manufacturing an element for a bodywork component according to claim 1, wherein the additional layer of plastic completely covers the heating track.

6. Method for manufacturing an element for a bodywork component according to claim 1, wherein the heating track is positioned on the plastic rough form in an arrangement compatible with the passage of electromagnetic waves through the plastic element, these waves being intended to be emitted by a sensor intended to be mounted perpendicularly to the element.

7. Method for manufacturing an element for a bodywork component according to claim 1, wherein the heating track further comprises a serpentine deicing portion.

8. Method for manufacturing an element for a bodywork component according to claim 1, wherein, prior to the welding step, a layer of insulation covering the heating track is locally destroyed by inputting electrical energy via a tool squeezing the first end of the connection member with the connection part of the track, preferably used in the squeezing step.

9. Method for manufacturing an element for a bodywork component according to claim 1, wherein the heating track is fixed on the first face of the rough form by welding by heating the track to a temperature allowing local melting of the plastic of the rough form.

10. Method for manufacturing an element for a bodywork component according to claim 1, wherein the connection member is held in position in the housing with the aid of complementary snap-in means carried on the second end of the connection member and the second face of the rough form, for example by means of a snap-in tab carried by the second end and cooperating with the second face of the rough form.

11. Element for a bodywork component, characterized in that it comprises:
a rough form made of plastic and comprising at least one housing on a first face of the rough form, said housing comprising at least one orifice extending between a bottom of the housing and a second face of the rough form opposite the first face,
an electrically conductive heating track positioned on the first face of the rough form, the heating track comprising a connection part,
an electrically conductive connection member comprising a first end positioned in the housing of the rough form and a second end extending through the orifice in the rough form so as to be accessible from the side of the second face of the rough form, the connection part of the heating track being affixed to the first end of the connection member, the first end and the connection part of the track being squeezed and welded together,
an additional layer of plastic, overmolded on the first face of the rough form, covering the heating track, the first end of the connection member, the housing and the orifice of the rough form.

12. Element for a bodywork component according to claim 11, wherein the connection part of the heating track is affixed to the first end of the connection member, forming at least one coil of the connection part of the heating track around the first end of the connection member.

13. Element for a bodywork component according to claim 11, wherein the first end of the electrical connection member is formed by a tab bent in a hook shape comprising a web connecting a first free branch and a second branch intended to be in contact with the bottom of the housing, and wherein the second end of the connection member is formed by an extension of the second leg, bent with respect to the second leg.

14. Element for a bodywork component according claim 11, wherein the connection member is held in position in the housing by means of complementary snap-in means carried on the second end of the connection member and the second face of the rough form, for example by means of a snap-in tab carried by the second end and cooperating with the second face of the rough form.

15. Element for a bodywork component according to claim 11, wherein the heating track is positioned on the plastic rough form in an arrangement compatible with the passage of electromagnetic waves through the plastic element, which waves are to be emitted from a sensor to be perpendicularly mounted on the element.

16. Element for a bodywork component according to claim 11, wherein the heating track further comprises a serpentine deicing portion.

17. Element for a bodywork component according to claim 11, wherein the heating track comprises an electrically conductive material selected from copper, tungsten or an alloy comprising copper or tungsten.

18. Element for a bodywork component according claim 11, wherein the heating track is covered with an insulating layer.

19. Element for a bodywork component according to claim 18, wherein the insulation is selected from enamel or insulating paint.

20. Element for a bodywork component according to claim 11, wherein the heating track is fixed on the first face of the rough form by local melting of the plastic of the rough form.
